(19) United States
(12) Patent Application Publication
(10) Pub. No.: US 2024/0241032 A1
(43) Pub. Date: Jul. 18, 2024

(54) Method and apparatus for measuring a force on at least one particle in a fluid, computer program product and computer-readable storage medium

(71) Applicant: Max-Planck-Gesellschaft zur Förderung der Wissenschaften E.V., Munich (DE)

(72) Inventors: Iliya Stoev, Dresden (DE); Nicola Maghelli, Dresden (DE); Moritz Kreysing, Dresden (DE)

(21) Appl. No.: 18/574,585

(22) PCT Filed: Jul. 30, 2021
(86) PCT No.: PCT/EP2021/071392

§ 371 Date: Dec. 27, 2023

(30) Foreign Application Priority Data
Jun. 29, 2021 (EP) 21182612.8

(51) Int. Cl. G01N 15/1434; G01N 15/1404; G01N 15/1429

(52) U.S. Cl. CPC G01N 15/1434; G01N 15/1404; G01N 15/1429; G01N 2015/1413; G01N 2015/1415; G01N 2015/1445

(57) ABSTRACT

The invention concerns a method for measuring a force on at least one particle in a fluid wherein an inhomogeneous field of hydrodynamic flows is generated in a fluid by specific dynamic localized heating events, the particle is spatially manipulated by the hydrodynamic flows, a spatial configuration of the particle(s) within the fluid is captured and at least one force acting on the particle(s) is determined by evaluating the captured spatial configuration of the particle(s). The invention concerns furthermore an apparatus for measuring a force on at least one particle in a fluid, a computer program product, and a computer-readable storage medium.

The present invention is mainly concerned with a method and an apparatus for measuring a force on at least one particle in a fluid. In further aspects, the invention provides a computer program product and a computer-readable storage medium assisting in the measurement of a force on at least one particle in a fluid.

The use of optical tweezers to measure forces acting upon mesoscopic particles has revolutionized fields from material science to cell biology [1]-[9]. However, the application of this technology is subject to certain prerequisites regarding the refractive index of the probe, [10], and its use may be limited in biological systems due to concerns about the effect on living processes, [11], [12].

Thermoviscous flows can be used for the positioning of particles. Thermoviscous flows have been described as the directed motion of aqueous media in response to travelling temperature fields [13], an emergent physical phenomenon driven by the thermal expansion of fluids in non-homogenous viscosity fields. In particular, thermoviscous flows have been used to transport aqueous solutions visualized by tracer particles or molecules along an optically defined path [13], [14]. More recently, it has been shown that these flows can also be induced in cells and developing embryos [15]-[17], where they give rise to a streaming of the cytoplasm, albeit with limited abilities to control the positioning of cytoplasmically immersed colloids.

An apparatus for spatially manipulating a particle in a fluid by means of hydrodynamic flows is known, e.g., from WO 2008/077630A1.

It can be considered a problem of the invention to provide a novel method and a novel apparatus for measuring forces on particles in a fluid. A further objective of the invention is to provide suitable software means assisting in the measurement of forces on particles in fluids.

This problem is solved by the method having the features of claim 1 and by the apparatus having the features of claim 33. As regards the software means, the problem of the invention is solved by the computer program product according to claim 41 and the computer-readable storage medium according to claim 42.

In the method for measuring a force on at least one particle in a fluid according to the invention (claim 1) an inhomogeneous field of hydrodynamic flows is generated in a fluid by specific dynamic localized heating events, the particle is spatially manipulated by the hydrodynamic flows, a spatial configuration of the particle(s) within the fluid is captured and at least one force acting on the particle(s) is determined by evaluating the captured spatial configuration of the particle(s).

The apparatus for measuring a force on at least one particle in a fluid according to the invention (claim 32) has the following features: a receptacle for receiving the fluid and the particle, a heating device for generating an inhomogeneous field of hydrodynamic flows within the fluid by specific dynamic localized heating events, a device for capturing at least parts of a spatial configuration of the particle(s) within the receptacle and a control unit for controlling the heating device and the device for capturing at least parts of a spatial configuration of the particle(s), for evaluating data from the device for capturing at least parts of a spatial configuration of the particle(s) and for determining at least one force acting on the particle by evaluating the spatial configuration of the particle

A computer program product according to the invention (claim 40) and a computer-readable storage medium according to the invention (claim 41) comprise, in each case, instructions which, when the program is executed by the control unit, causes the control unit to carry out a method according to the invention with the steps of
A) activating the device for capturing at least parts of a spatial configuration of the particle(s), in particular the imaging device, to capture an actual spatial configuration of the particles within the receptacle,
B) determining control signals for the heating device suitable for a specific dynamic localized heating event to be applied to the fluid in dependence of at least one recent spatial configuration of the particle(s) and a previously defined target(s) configuration of the particle(s),
C) activating the heating device to apply the specific dynamic localized heating event as determined in step B) at least once to the fluid,
D) repeating at least one or all of the steps A) to C), and
E) determining a force acting on a particle in dependence of a captured spatial configuration of the particle(s).

Advantageous variants of the method according to the invention and preferred embodiments of the apparatus according to the invention will be described in the following, in particular with respect to the dependent claims and the attached figures.

The apparatus according to the invention can be designed for carrying out the method according to the invention.

The instructions of the computer program product and/or of the computer-readable storage medium can in particular serve the purpose of activating the control unit to carry out the method according to one of the claims 1 to 32.

The basic idea of the invention is to use specific dynamic localized heating events to spatially manipulate particles in a fluid, to generate an inhomogeneous field of hydrodynamic flows in the fluid, to observe or capture the position of at least one particle in the inhomogeneous flow field and to derive a force acting on at least one particle by evaluating the observed configuration of the particle.

The specific dynamic localized heating events may be determined in each case in dependence of a target configuration of the particle(s) and a recently captured actual configuration of the particle(s) in the fluid. The specific dynamic localized heating events serve the purpose of generating sequences of hydrodynamic flows within the fluid. The spatial manipulation of the particles may be carried out in a closed-loop control wherein an actual captured particle configuration may serve as feedback for the determination of a specific dynamic localized heating event to be applied next.

It should generally be understood that the use of the term “target” does not necessarily imply that a particle to be manipulated and/or analysed ever reaches, e.g., a target location. In typically cases, a target location serves for the purpose of calculating the necessary specific localized heating events and the particle is, e.g., against the action of an external force, continuously pushed by the specific localized heating events in the direction of a target location.

It should also generally be understood that the term recent spatial configuration does not necessarily imply that the full coordinates of the particle(s) to be manipulated and/or analysed are known. Rather, a spatial configuration in this respect can be realized by at least one parameter or coordinate characterizing the particle(s) to be manipulated and/or analysed.

Essential advantages of the present invention are that the method as such is a non-contact trapping method based on optically induced hydrodynamic flows, i.e., the method can be applied to sensitive particles. The inventors could demonstrate a linear force-extension relationship and could detect forces in the femtonewton-range with near thermally limited sensitivity. The technology according to the invention removes the need for lasers to touch particles and there are, in principle, no material constraints on the particles that can be analysed. Furthermore, the methodology can be employed with standard optical microscopes without a requirement for special chambers, making it possible to investigate localized forces within more complex materials. Thus, optically induced hydrodynamic flows facilitate highly sensitive, non-invasive force measurements with low constraints on the nature of the sample.

The term spatial manipulation of a particle in the fluid generally means that the particle-fluid system in a receptacle is influenced, such that the particle is moved from one point to another and/or from one orientation to another as compared, e.g., to a reference frame in which the receptacle is stationary. Spatial manipulation can also mean, though, that a particle is kept at a certain position against the action of other, e.g., external forces acting on the particle.

In preferred embodiments of the method according to the invention, the spatial manipulation of the particle(s) comprises at least one of: pushing or moving specified particle(s) towards specified target locations in the fluid, moving specified particle(s) along specified paths in the fluid, keeping specified particle(s) in specified target locations in the fluid, keeping specified particle(s) in specified target orientations in the fluid, pushing or moving specified particle(s) towards specified target orientation(s) in the fluid.

In preferred embodiments of the method according to the invention, the field of hydrodynamic flows, at least partly in regions where particles to be analysed are present, decreases in the direction of the field. It has been found that, at least in such situations, the particle(s) to be analysed can reach a steady state.

Generally, the method and the apparatus according to the invention can be used for any kind of fluid in which hydrodynamic flows can be generated by dynamic localized heating of the fluid. In preferred embodiments of the method according to the invention, the fluid is a liquid and, in particular, contains water or is water.

Generally, the method and the apparatus according to the invention can be used to manipulate any suspended particle in a fluid which can at least partly move freely in the fluid. In preferred variants of the method according to the invention, the particle(s) to be manipulated is/are at least one of the following: a biological particle, a cell, a virus, a tissue fragment, a metal particle, a composite material particle, a polymer particle, a nanoparticle, a spherical bead, a magnetic bead, a cellular organelle, or a phase-separated droplet that itself is containing protein, RNA or other biomolecules, a tethering molecule.

According to the invention, hydrodynamic flows are generated in the fluid by means of dynamic localized heating of the fluid and the manipulation of a particle is achieved by the particle being carried by the generated hydrodynamic flow.

It would, in principle, also be possible to generate hydrodynamic flows with specific dynamic localized heating events having a negative sign, i.e., events where hydrodynamic flows are introduced into the fluid by means of dynamic localized cooling of the fluid and the manipulation of a particle is again achieved by the particle being carried by the generated hydrodynamic flows.

In contrast to the phenomenon of thermophoretic motion which is strongly dependent on the specific types of particles and the specific liquid surrounding these particles, the general principle of the mechanism underlying the present invention is independent of the specific nature of the particles. In a thermophoretic motion, different particles will generally move differently, e.g., at different speeds and even in different directions. In hydrodynamic flows, as being used in the present invention, the particles will move essentially according to the physics of hydrodynamics. The mechanism of the present invention is governed essentially only by the thermodynamic properties of the used fluid, e.g., water. In the case where electromagnetic radiation, e.g. a laser, is used for heating the sample, the optical properties of the fluid also play an important role. The hydrodynamic flows generated by dynamic localized heating of the fluid are also termed thermoviscous flows.

In principle, the dynamic localized heating of the fluid can be brought about by any energy deposition into the fluid which leads to the intended thermoviscous flows. E.g., the dynamic localized heating can be introduced by specific heating devices attached to the receptacle via heat-conducting connections and which are selectively heated. In preferred embodiments of the method according to the invention, the dynamic localized heating of the fluid is brought about by a laser or an infrared laser.

In another preferred embodiments of the method according to the invention, the dynamic localized heating of the fluid is brought by light emitting diodes, e.g., infrared light emitting diodes.

Correspondingly, in a preferred embodiment of the apparatus according to the invention, the heating device has a laser for providing the energy for the dynamic localized heating and optical means, such as a scanner, galvo-scanner, quasistatic scanner, a spatial light modulator, acousto-optical scanner, or any other suitable device, for relaying heating laser radiation to variable, controlled locations in the fluid, and enabling the dynamic scanning of the heating laser beam across the sample.

An optical assembly as described in WO 2008/077630A1 can be used for the dynamic localized heating of the fluid. In this regard, the respective contents of WO 2008/077630A1 are included in the present disclosure.

In preferred embodiments of the method according to the invention, the dynamic localized heating events of the fluid are brought about by repetitive scanning of a focal volume of the laser along an especially selected path or a trajectory in the sample.

More specifically, the determination of the specific dynamic localized heating events to be determined to the fluid can comprise the determination of at least one of: 2-dimensional scan path in the fluid, 3-dimensional scan path in the fluid, laser intensity, laser scanning speed, scanning frequency of the laser, number of times the scanning path is scanned.

A specific dynamic localized heating event can comprise only one scan of a laser scan path or many, e.g., 100, scans of the same laser scan path.

Application of the specific dynamic localized heating as determined means that the determined dynamic heating pattern is applied to the fluid. This can be done only once or a plurality of times one after another. The heating device of the apparatus according to the invention will then correspondingly be activated by the control unit.

Generally, a scan path can be anywhere in the receptacle, and can consist of one or more straight or arbitrary shaped segments of arbitrary length, which need not necessarily be continuous. A scan path can be parallel to a connecting vector between a target destination and an actual position of the particle. The scan path can for example either be centred on the particle, ending slightly before it, or starting slightly after it. Many other variants are possible in this regard. The laser scan can be applied along the path, with a typical scan rate of, e.g., 1-3 kHz, which is sufficiently slow to allow for the relaxation of temperature fields between successive scan periods. The scan rate can vary along the scan path.

In further preferred embodiments of the method according to the invention, the paths along which the laser is scanned can be chosen, such that the heating radiation does not hit the particle(s) to be manipulated and analysed. I.e., the particle(s) is (are) spatially manipulated essentially without being contacted by heating laser radiation. The danger of the particles as such, or the receptacle, e.g., living cells or embryos, to be influenced or harmed by the heating radiation is thereby minimized.

In further preferred embodiments of the method according to the invention, a scan rate of the repetitive scanning is chosen, such that temperature fields in the sample can relax between successive scans. A general heating of the sample can thus be avoided.

The specific dynamic localized heating events to be applied to the fluid can further be individualized by being determined also in dependence of a mobility of particle(s) in the fluid. The accuracy of the manipulation, in particular the positioning, can thus be further improved. The mobility of particles to be manipulated can be derived from the observed data.

For the receptacle, which receives the fluid and the particles to be manipulated, components known in the art can be used. It is important that the receptacle allows the specific dynamic localized heating to be introduced into the fluid. E.g., the receptacle described in WO 2008/077630A1 can be used for carrying out the invention. In this regard, the respective contents of WO 2008/077630A1 are included in the present disclosure.

In a preferred embodiment of the invention, the receptacle has means for controlling the basic temperature of the fluid.

The control unit for controlling the heating device and the imaging device and for evaluating image data from the imaging device can typically be a PC or equivalent devices, with peripheral components as known in the art.

ANSPRUCH 33 The device for capturing at least parts of a spatial configuration of the particle(s) can be any device that is able to capture a signal which encodes at least parts of a spatial configuration of the particles. This device can in particular be an optical device and can, e.g., be at least one of an imaging device, a lenseless camera, a quadrant photodiode.

The imaging device serves the purpose of capturing actual configurations of the particles to be manipulated in the fluid. It can be any, in particular optical, device with which at least the portions of the receptacle can be captured or imaged which contain particles to be manipulated. In preferred embodiments of the invention, the imaging device is a microscope. The microscope can be a computer-controlled microscope and does not need to allow a visual observation of the sample. Preferably, the acquisition of images is at least partly automated and image algorithms are being used for the evaluation of the captured configurations of the particles.

For example, the microscope can be designed for carrying out at least one of the following techniques: Fluorescence Microscopy, Multi-Photon Fluorescence Microscopy, Widefield Microscopy, Scanning Microscopy, Dark-Field Microscopy, Confocal Microscopy, Light Sheet Microscopy, Localization Microscopy, Structured Illumination Microscopy, Photoactivated Localization Microscopy (FPALM), Stochastic Optical Reconstruction Microscopy (STORM), Stimulated Emission Depletion Microscopy (STED), Ground State Depletion Microscopy (GSD), Saturated Pattern Excitation Microscopy, Saturated Structured Illumination Microscopy (SSIM), Light Field Microscopy (LFM), Fourier Light Field Microscopy (FLFM), Oblique Plan Microscopy (OPM).

The microscope can relay imaging radiation onto and into the sample and can relay back radiation emitted from the sample in response to the imaging radiation, e.g., fluorescence radiation, via the same microscope objective that is also used for introducing the heating radiation into the sample.

The capturing of the actual spatial configuration of the particle(s) can comprise at least one of the following: a 1-dimensional position of the particle(s), a 2-dimensional position of the particle(s), a 3-dimensional position of the particle(s), a measurement of an orientation of the particle(s) within a plane, a measurement of a 3-dimensional orientation of the particle(s) in space.

In particularly preferred embodiments of the method according to the invention the spatial configuration of the particles to be manipulated and to be analysed are evaluated over time.

For the realization of the invention, it is necessary that the field of hydrodynamic flows is inhomogeneous. An equivalent language therefore is that at least one vector component of the field of hydrodynamic flows has a non-zero gradient or, simply, that the field of hydrodynamic flows is not constant in at least a certain volume of the sample where the particle(s) to be manipulated and to be analysed are localized. In particularly preferred embodiments, though, the inhomogeneous field of hydrodynamic flows comprises at least one stagnation point. The particle(s) to be manipulated and to be analysed can then be trapped at least temporarily in the vicinity of the stagnation point. In such a situation, the hydrodynamic flows generate a quasi-potential which allows the determination of a force acting on the particle(s).

In a situation with a hydrodynamic field having a stagnation point, the capturing of the configuration of the particle to be manipulated and analysed can be an observation of a deviation of an actual position of the at least one particle from the stagnation point. The force acting on the particle can then be determined in dependence of the observed deviation.

For example, the inhomogeneous field of hydrodynamic flows comprising at least one stagnation point can be generated by at least two hydrodynamic flows directed in opposite directions toward the stagnation point. In an effort to obtain a quasi-stable situation, the at least two hydrodynamic flows directed in opposite directions can be rotated in a plane around the stagnation point.

In other preferred embodiments of the method according to the invention, a stagnation point can be generated with only one hydrodynamic flow, in particular where an external force, e.g., the gravitational force is acting on the fluid, or where a physical barrier already constrains the particle in one direction, e.g., trapping against a plane surface.

More specifically, an azimuthal direction in which the at least two hydrodynamic flows directed in opposite directions are applied can be chosen in dependence of a captured spatial configuration of the particle, in particular in dependence of at least one of the measured azimuthal and radial coordinates of the particle(s) in relation to the stagnation point. In this way, a two-dimensional quasi-potential for the particle(s) to be manipulated and to be analysed can be generated.

In further preferred embodiments of the method according to the invention, at least one external force is applied to the particle. The external force can be at least one of: a magnetic force, an electrostatic force, a gravitational force, frictional forces from additional flows in the system, a force exerted on a particle by a tether, in particular a molecular tether, a force generated by an optical trap, in particular an optical tweezer, a force exerted by a tethered molecule, e.g., a tethered polymer. And external force allows a quantitative determination of a force acting on a particle. In preferred variants of the invention, the external force is time-dependent or constant for at least a specified period of time. It is also possible to have oscillating external forces which allow mechanical parameters of the system fluid-particle to be determined.

For a calibration of measured forces, it can be useful to impose external forces, e.g., electrostatic, or magnetic forces, of a known magnitude on the fluid containing the particles to be manipulated and analysed. Deviations of the position of a particle from an equilibrium position in the effective potential, e.g., from a stagnation point, can then be measured in dependence of the magnitude of the external force and, thus, the magnitude of the force acting on the particle through the hydrodynamic flows can be determined.

ANSPRUCH 32 In a further preferred embodiment of the method according to the invention, the particle to be manipulated and analysed is a tethered molecule, a flow field having at least two stagnation points is generated within the fluid, and at least two portions of the tethered molecule, e.g., the terminal particles of the tethered molecule, are held in the stagnation points by the hydrodynamic flows.

It will then be possible to measure a force acting within the tethered molecule, in particular between the terminal particles, and in particular in dependence of an elongation of the tethered molecule.

A calibration of the measured forces can alternatively or additionally also be achieved by observing fluctuating movements, in particular a mean distance from an equilibrium position of the particle in the effective potential. With the assumption that the mean amount of energy in each degree of freedom is k_{B}T (k_{B}=Boltzmann constant, T=temperature) the force acting on the particle can be determined. In this regard, preferred embodiments of the method according to the invention are characterized in that the force acting on the particle is determined by evaluation of a statistical distribution, e.g., of the lateral positions of the particle in the vicinity of a stagnation point and a temperature of the fluid.

The invention allows in particular to study the velocity and dynamics of a trapped particle in the absence of external forces when the particle travels back to a stagnation point of a field of hydrodynamic flows.

The method of the invention is realized when one force acting on one particle is determined. By evaluating an actual spatial configuration of a particle, e.g., an orientation of a particle in relation to a surrounding field of hydrodynamic flows it is also possible to determine a torque acting on the respective particle.

In this regard, it may be useful if the fluid contains particles, e.g., fluorescent particles, such as tracer particles, which enable a capturing of the field of hydrodynamic flows. The specific localized heating events can be determined in dependence of at least one of: a recently captured spatial configuration of the particle(s) and a recently captured field of hydrodynamic flows.

As regards the spatial manipulation of the particle(s) to be analysed, the specific dynamic localized heating events to be applied to the fluids can be determined in a feedback loop. More specifically, in a preferred embodiment of the method according to the invention, at least one target spatial configuration of the particle(s) in the fluid is defined and that the following further steps are carried out:
a) an actual spatial configuration of the particle(s) is captured,
b) a specific dynamic localized heating event to be applied to the fluid is determined in dependence of at least one recent actual spatial configuration of the particle(s) and a target configuration of the particle(s),
c) the specific dynamic localized heating event as determined in step b) is applied at least once to the fluid and
d) at least one or all of steps a) to c) are repeated.

It is possible to vary and/or adapt a number of repetitions or a repetition rate of a loop containing at least some or all of steps a) to c) of claim 1 to a specific manipulation task.

Correspondingly, a preferred embodiment of the apparatus according to the invention is characterized in that the control unit is designed for:
A) activating the device for capturing at least parts of a spatial configuration of the particle(s), in particular the imaging device, to capture an actual spatial configuration of the particle(s) within the receptacle,
B) determining control signals for the heating device suitable for a specific dynamic localized heating event to be applied to the fluid in dependence of at least one recent spatial configuration of the particle(s) and a previously defined target configuration of the particle(s),
C) activating the heating device to apply the specific dynamic localized heating event as determined in step B) at least once to the fluid and
D) repeating at least one or all of the steps A) to C).

Definition of a target spatial configuration means that a certain configuration into which the particle or the particles to be manipulated is defined. This can, e.g., be done by a user at the computer screen on the basis of a measured actual configuration or an actual image of the particles. The definition of a target configuration can be assisted by image evaluation software which, e.g., recognizes certain structures in the measured image data. The target spatial configuration of the particle(s) in the fluid can comprise at least one of: specified target location(s) of the particle(s) in the fluid, in particular a stagnation point, specified target velocity or velocities of the particle(s) in the fluid, specified target orientation(s) of the particle(s) in the fluid, specified target rotation speed(s) of the particle(s) in the fluid.

The target spatial configuration of the particle(s) in the fluid can furthermore be a 1-dimensional localization of the particle(s), a 2-dimensional localization of the particle(s) or a 3-dimensional localization of the particle(s).

For the purposes of force measurement, a target location can in particular, be realized by a stagnation point in the flow field.

The target configuration can additionally or alternatively also include at least one of the following requirements: (a) specified particle(s) be not in a specified location, (a) specified particle(s) be as far away from (a) specified location(s) as possible, (a) specified particle(s) be at least in (a) specified distance(s) from (a) specified location(s), specified particles be as close together as possible, specified particles must not touch each other, particles of a different kind being treated differently.

A key feature of the present invention concerns, in step b), the determination of a specific dynamic localized heating event to be applied to the fluid in dependence of at least one recent actual spatial configuration of the particle(s) and a target configuration of the particle(s). In this regard, a cost function can be calculated on the basis of a recent, in particular the most recent, actual spatial configuration of the particles and a target configuration of the particles. The specific dynamic localized heating events can then be determined in dependence of the cost function. The cost function can be a scalar function of at least one recent actual spatial configuration of the particle(s) and a target configuration of the particle(s) and/or a description of the desired target configuration. A description of the target configuration can be that, e.g., all particles of a first kind should be moved to the left, and all particles of a second kind should be moved to the right side to enable an effective sorting.

For example, after an application or each application of the specific dynamic localized heating event in step c), the actual configuration can be captured and the cost function can then be calculated for the new configuration and, if the cost function has decreased from the most recent value, step c) can be repeated with the same specific dynamic localized heating event, or, if the cost function has increased from the most recent value, step b) can be carried out anew.

The method of the invention is realized when a force acting on one particle is determined. It is also possible, though, that at least two particles are simultaneously spatially manipulated and/or that forces acting on at least two particles are simultaneously determined. This means that the actual configuration of a plurality of particles is captured. The specific dynamic localized heating events can then be determined such that both (or more) particles are moved or manipulated but also such that essentially only one particle is manipulated or moved at a time. Simultaneously means in this context that the forces acting on the plurality of particles are determined from one and the same observed spatial configuration of the particles.

In principle, each particle to be manipulated can be considered individually. E.g., each particle can individually be moved to a certain location or to a certain orientation. For certain applications, though, it may be useful to consider certain types of particles. I.e., a plurality of particles to be spatially manipulated can comprise at least one subset of equivalent or identical particles The cost function can then be invariant with regard to exchange of equivalent or identical particles. The complexity of the underlying mathematical task can thus be reduced.

E.g., in a configuration with at least two particles to be manipulated, the particle being mainly manipulated, in each case, in the next step can be the particle which is farthest away from at least one of a target position and a target orientation associated with the respective particle.

More specifically, the cost function can contain at least one of the following arguments: distance of a specific particle to a specific target location of this particle, reciprocal distance of a specific particle to a specified location, distance of a specified type of particles to a specific target location of the respective type of particles, reciprocal distance of a specified type of particles to a specified location specific for the respective type of particles, angle between an actual particle orientation and a target orientation of the respective particle or the respective type of particle, difference between an actual particle velocity and a target velocity of the respective particle or the respective type of particle.

In further preferred embodiments of the method according to the invention, between steps a) and b) the following further step can be carried out: the particle(s) to be manipulated is or are associated with at least one of a target position and a target orientation. Association of a particle with a specific target position means that the target position is attributed to the respective particle.

In further preferred embodiments of the method according to the invention, a tracking of the particle(s) can be carried out by identifying particles present in a captured new actual configuration with particles in the most recent actual configuration. Thus, trajectories of individual particles can be derived from a sequence of actual configurations.

In further preferred embodiments of the method according to the invention, after the tracking of the particles, a target configuration can be reassessed and, if the target configuration is changed to a new target configuration, the particles can then be associated, in each case, with at least one of a new target position and a new target orientation. Thus, the system can dynamically react to a change of the target configuration and can change the attribution of the particles to specific target configurations on the fly.

In further preferred embodiments of the method according to the invention, at least some of the following data can be stored in a database: previous actual spatial configurations of the particle(s), previous dynamic localized heating events applied to the fluid determined on the basis of at least a respective actual spatial configuration and a target configuration and changes in the actual spatial configurations of the particle(s) caused by the respective dynamic localized heating event applied to the fluid.

Future dynamic localized heating events to be applied to the fluid can be calculated using at least parts of the data stored in the database, in particular making use of machine learning/artificial intelligence.

Further features and advantages of the invention will be described in the following with respect to the attached figures. Therein shows:

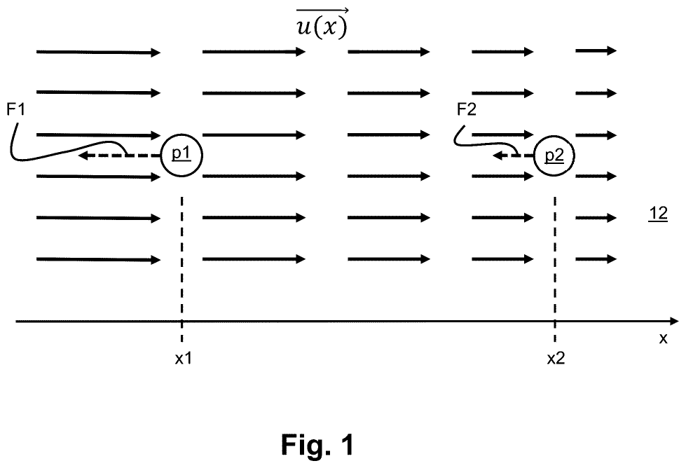

FIG. 1: a schematic diagram illustrating the measurement principle of the present invention;

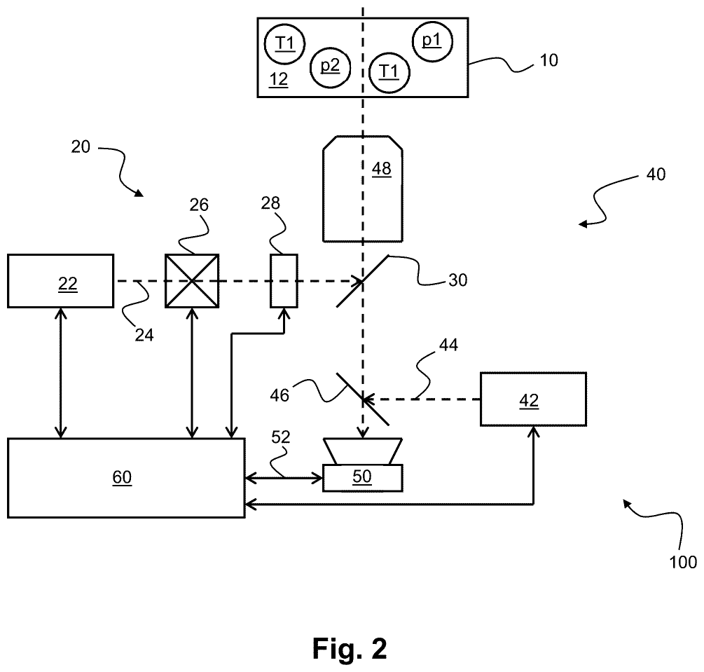

FIG. 2: a schematic diagram of an apparatus according to the invention;

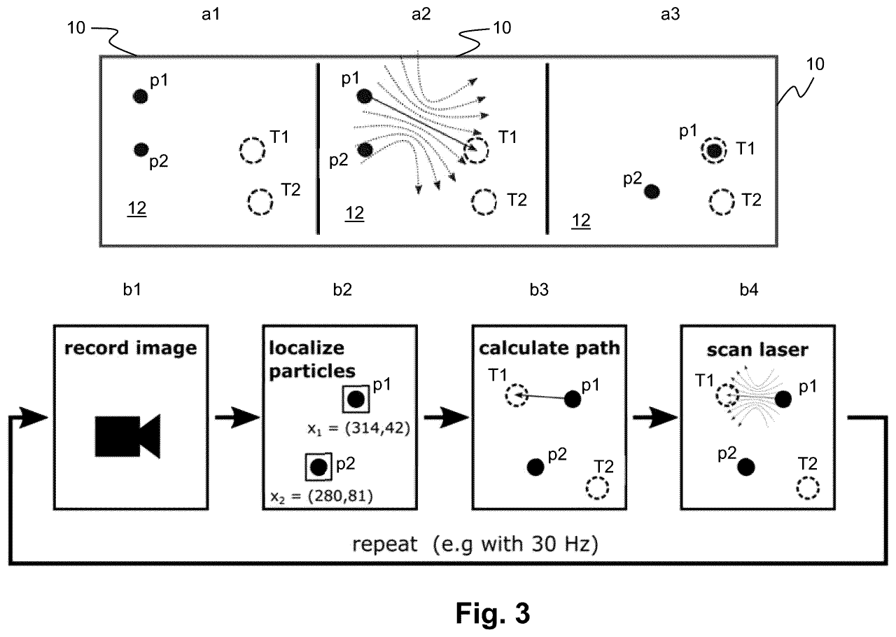

FIG. 3: schematic diagrams to illustrate the aspect of spatial manipulation in a method according to the invention;

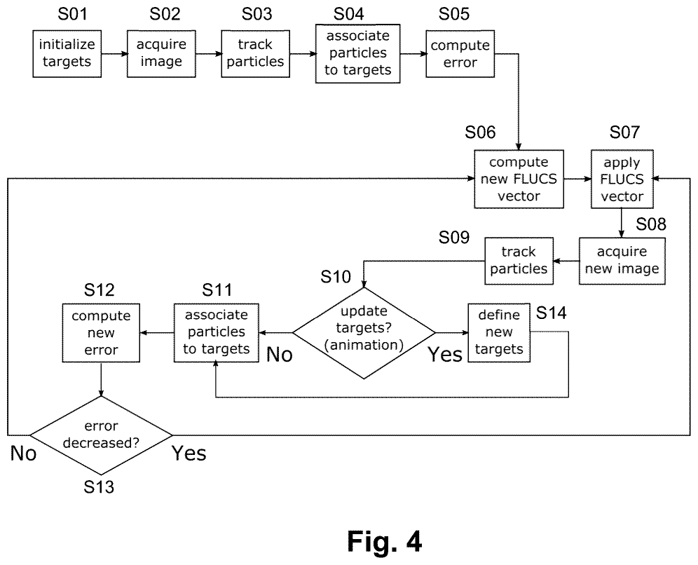

FIG. 4: a flowchart further illustrating the aspect of spatial manipulation in a method according to the invention;

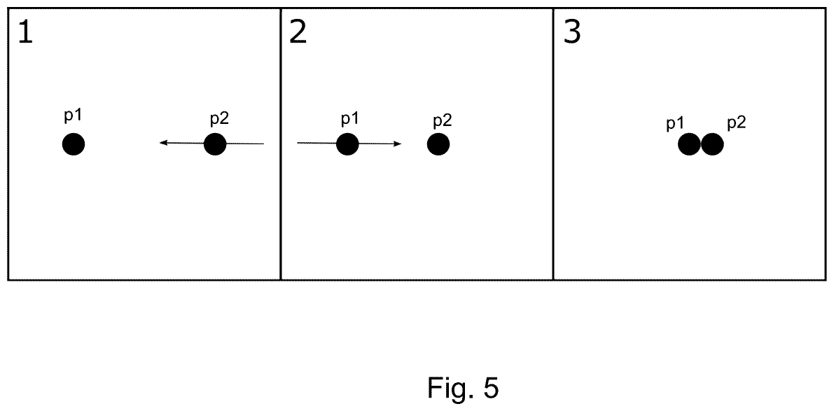

FIG. 5: diagrams illustrating a simple example of manipulating two particles;

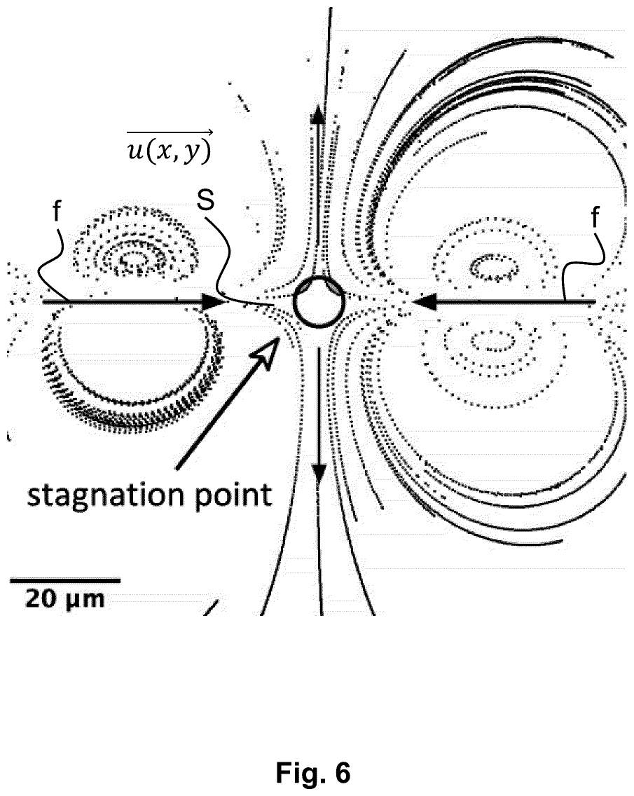

FIG. 6: an example of a field of hydrodynamic flows having a stagnation point;

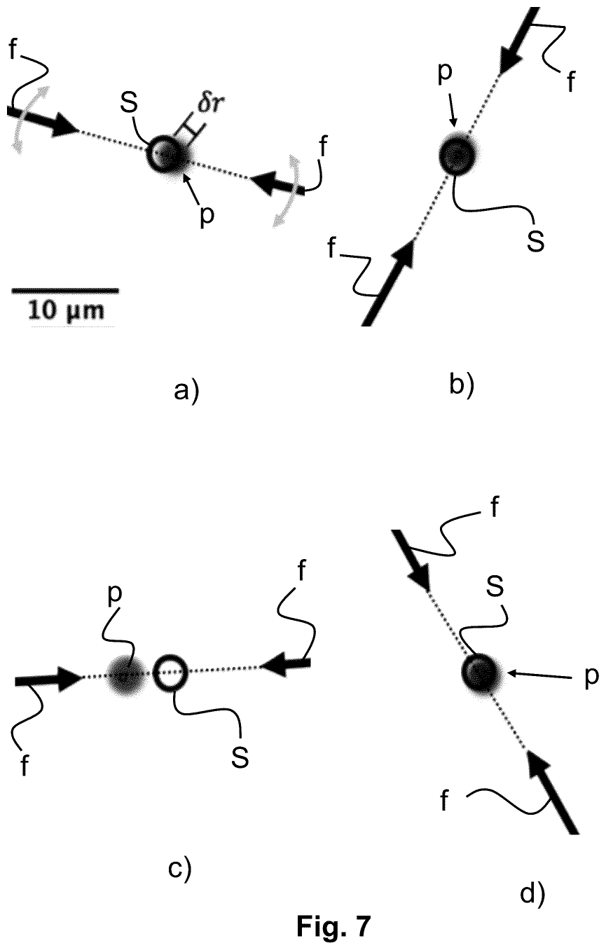

FIG. 7: diagrams illustrating the trapping of a particle in the vicinity of a stagnation point in a field of hydrodynamic flows similar to the one shown in FIG. 6;

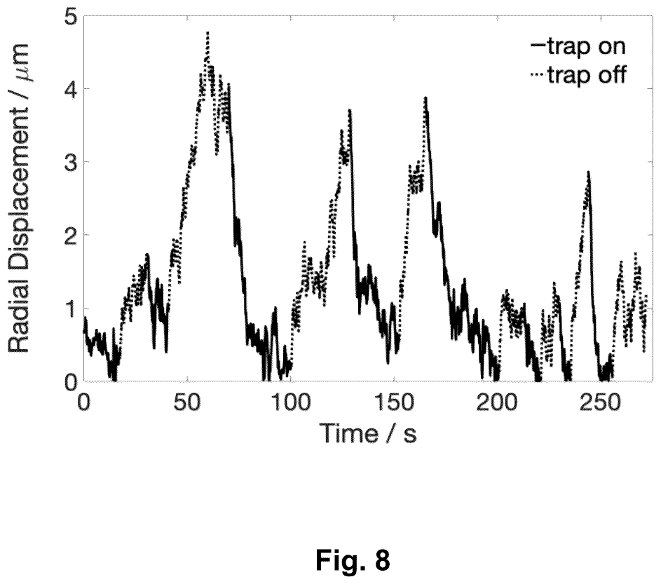

FIG. 8: a diagram showing a radial displacement of a particle from a stagnation point over time in a situation where the hydrodynamic trap is periodically switched on and off;

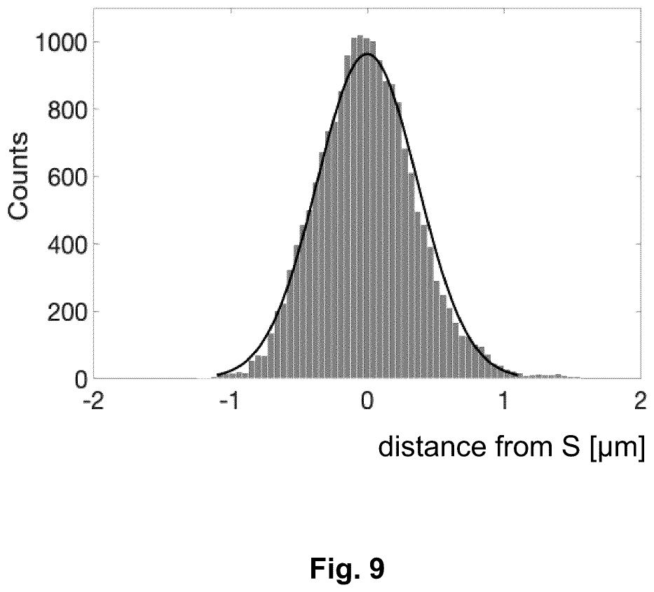

FIG. 9: a histogram of the phase space explored by a trapped particle;

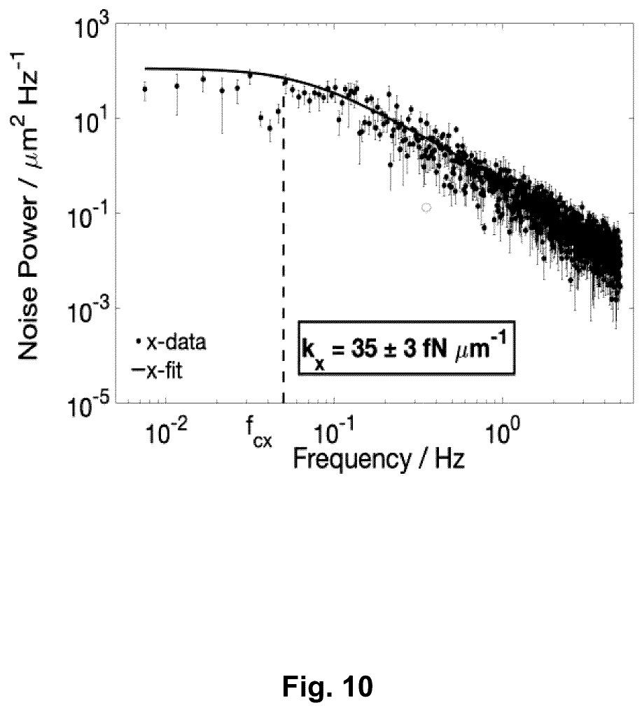

FIG. 10: a diagram showing power spectral density function or the mean-squared displacement of a particle obtained from the raw positional data of a probe-particle;

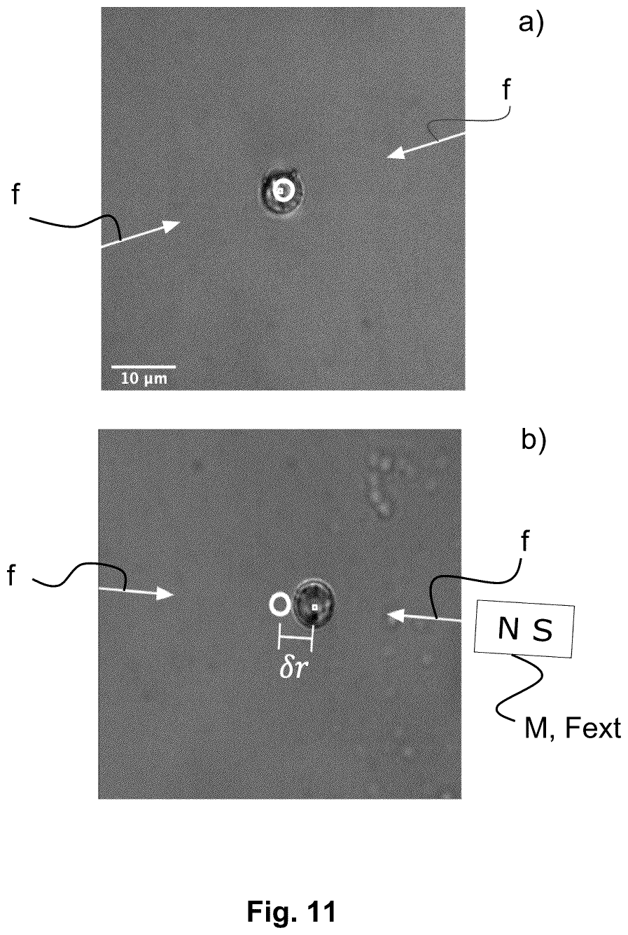

FIG. 11: captured images in an example where an external magnetic force was applied and the analysed particle was a magnetic spherical bead;

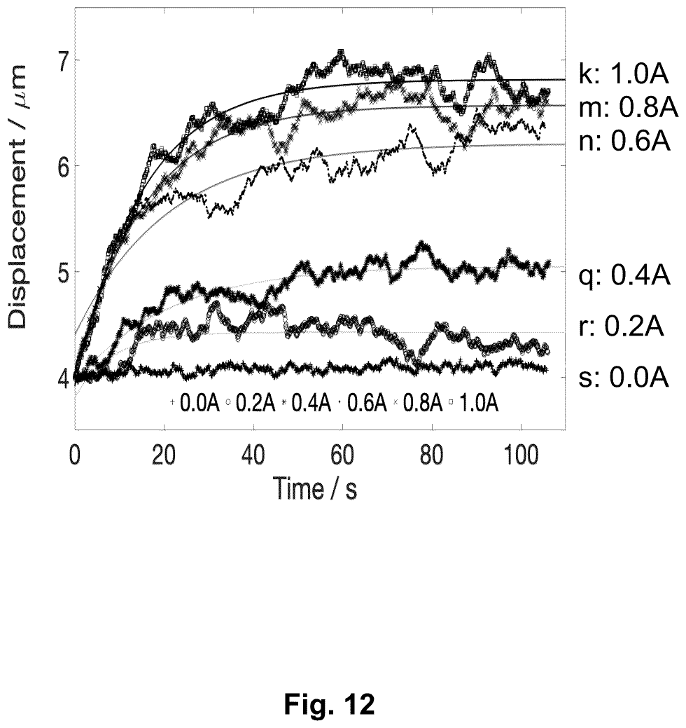

FIG. 12: a diagram showing the displacement of the probe-particle bead away from the stagnation point over time for different magnitudes of the applied external magnetic force; and

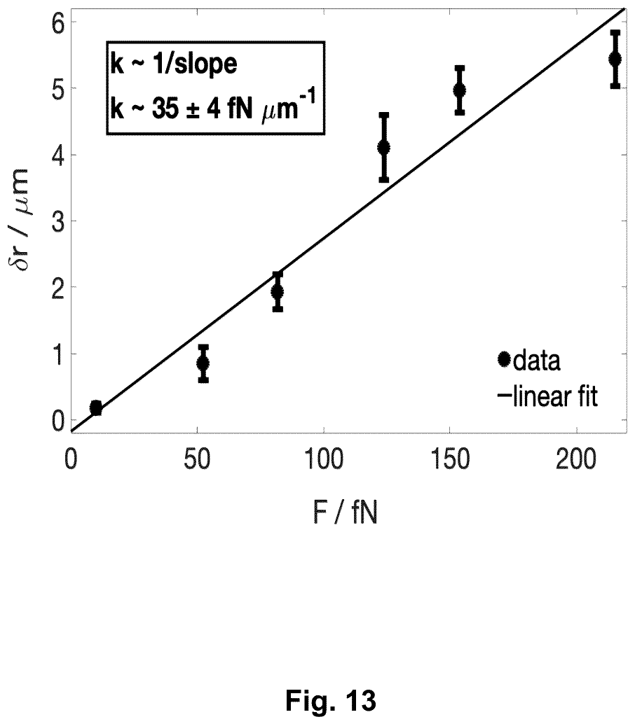

FIG. 13: a diagram illustrating an estimation of the stiffness of the trap shown in FIG. 7 and

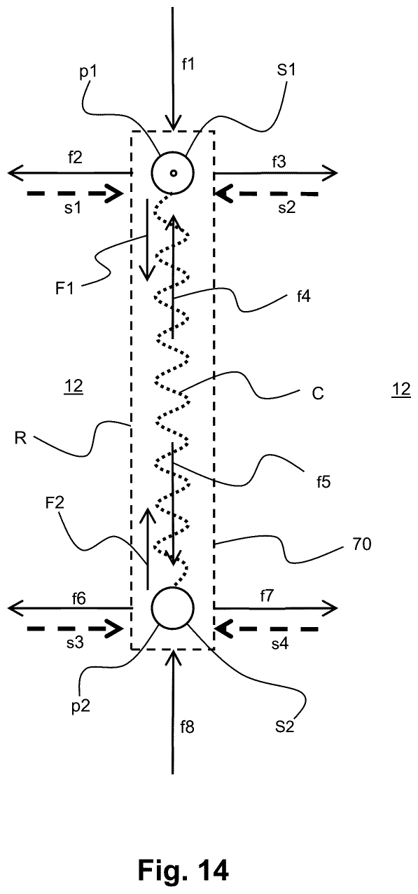

FIG. 14: a schematic representation of a further preferred embodiment for carrying out the invention.

Equal and equivalent components generally have the same numerals in the figures.

The principle underlying the present invention will be explained with reference to FIG. 1.

FIG. 1 shows a portion of a fluid 12 in a receptacle (not shown) where an inhomogeneous field \vec{u}(x) of hydrodynamic flows is generated by localized heating events. More specifically, the localized heating events generate thermoviscous flows. This process has been described and discussed in the literature. In the schematic example shown in FIG. 1, the hydrodynamic flow has a component in the x-direction and the magnitude of flow decreases with increasing x. It is clear that, in reality, with an incompressible fluid, like water, such a situation, where the hydrodynamic flow has a component only in one direction, would not be possible and that there will always be components perpendicular to the x-direction. In the example of FIG. 1, two particles p1 and p2 are localized within the inhomogeneous field \vec{u}(x) of hydrodynamic flows at positions x1 and x2. One can now ask what kind of force is necessary to keep particles p1 and p2, respectively, at their respective positions. In detail, the force will depend on the properties of the fluid 12, e.g., water, in particular its temperature-dependent viscosity, as well as the properties of the particle, e.g., cross-section, geometrical form, and surface properties.

For spherical non-interfering particles of a homogeneous composition and having smooth surfaces and a laminar flow, the frictional force imposed on the particle is given by Stokes' law, i.e., by

$$\vec{{F}_{d}} = 6 π η R \vec{u ( x )}$$

wherein:
\vec{F_{d}} the frictional force acting on the interface between the fluid and the particle;
η the dynamic viscosity of the fluid, e.g., water;
R the radius of the spherical particle;
\vec{u(x)} the flow velocity relative to the particle.

Coming back now to FIG. 1: for identical particles p1 and p2, the force F2 to keep particle p2 at its location x2 will be smaller than the force F1 to keep particle p1 at its location x1 More generally, in the example shown in FIG. 1, the respective force will decrease with increasing value of x.

The invention essentially consists in generating a suitable inhomogeneous field of hydrodynamic flows in the fluid by means of sequences of specific localized heating events applied to the fluid and by using the position-force relationship for the measurement of forces acting on the particles.

An embodiment of an apparatus 100 according to the invention will be described in the following with reference to FIG. 2. The apparatus 100 shown in FIG. 2 is designed for carrying out the method according to the invention. Details of the spatial manipulation of the particles in the fluid will, in the following, be described with reference to FIGS. 3 to 5. An embodiment of the method according to the invention will then be described with reference to FIGS. 6 to 13.

As essential components, the apparatus 100 as shown in FIG. 2 has a receptacle 10 for receiving the fluid 12 and the particles p1, p2 to be manipulated, a heating device 20 for generating hydrodynamic flows within the fluid 12 by dynamic localized heating of the fluid 12, an imaging device 40 for imaging at least parts of the receptacle 10, and a control unit 60 for controlling the heating device 20 and the imaging device 40 and for evaluating image data 52 from the imaging device 40.

The dynamic localized heating is designed to bring about a spatial manipulation of the particles p1, p2 within the receptacle 10 by hydrodynamic flows. The fluid 12 and the particles p1, p2 contained therein, are also termed the sample.

More specifically, in the example shown in FIG. 2, the heating device 20 has a laser 22, e.g., an infrared laser, for providing heating radiation 24. The heating radiation 24 is guided via an optical path into the sample, i.e., into the receptacle 10 containing the fluid 12 and the particles p1, p2, to be manipulated and analysed. In the example shown in FIG. 2, the optical path contains a scanner 26, a beam shutter 28, a beam splitter 30, and a microscope objective 48. By means of the scanner 26 the heating radiation 24 can be guided to variable locations within the receptacle 10. The beam shutter 28 serves the purpose of preventing heating radiation 24 from reaching the receptacle 10. The beam splitter 30 can, e.g., be a dichroic mirror which directs the heating radiation in the direction of microscope objective 48. In the example shown in FIG. 2, the scanner 26 and the beam shutter 28 can send status information back to the control unit and can be controlled by the control unit 60.

It is clear that FIG. 2 is a schematic diagram and that in reality the optical beam path can have a plurality of further components which are not shown in FIG. 2. More specifically, the optical setup can be as described in WO 2008/077630 A1. The optical assembly of FIG. 2 is the optical setup of an inverted microscope. Other geometries are, of course, possible. It is clear that for this inverted setup of an inverted microscope and heating via a laser, the receptacle 10 must have a window allowing for the heating radiation and the imaging radiation 44 to enter the sample. More generally, an apparatus or receptacle with localized heaters and/or an upright microscope is also possible, which would not require such a window. The receptacle 10 in FIG. 2 can, e.g., be a Petri dish. The receptacle 10 can have means for controlling the temperature of the fluid 12 which are also not shown in FIG. 2. Such means for controlling the temperature of the fluid are also described in WO 2008/077630 A1 to which reference is made in this regard.

The imaging means 40 in the example of FIG. 2 is realized by a microscope, e.g., a widefield fluorescence microscope. Many other imaging and microscope techniques are possible as described above. The microscope, which is also shown only schematically comprises light source 42, a beam splitter 46 and the microscope objective 48. Imaging radiation 44 provided by the light source 42, e.g., a laser, is guided by the beam splitter 46, e.g., a dichroic beam splitter, in the direction of the microscope objective 48. The imaging radiation passes through beam splitter 30, enters the microscope objective 48 and is focused by the microscope objective into the sample, i.e., into the fluid 12 containing, in the schematic example, the particles p1, p2 to be manipulated.

Fluorescence radiation radiated back from the sample, e.g., from dyes with which, e.g., the particles to be manipulated are prepared, or autofluorescence light travels back through the microscope objective 48, beam splitter 30, and beam splitter 46 and reaches an optical detector 50 and is detected there. The optical detector 50 can be a camera which can record images of a field of view as propagated by the optical beam path, i.e., the camera can capture an actual spatial configuration of the particles p1, p2 within the receptacle 10. Both the light source 42 and the optical detector 50 are controlled by the control unit 60 and can, in each case, send back status data to control unit 60.

In the schematic example of FIG. 2, target positions T1, T2 are shown schematically in the receptacle 10 of FIG. 2. The target positions T1, T2, can represent the locations to which the particle p1 and p2, respectively, are to be spatially manipulated, i.e., the spatial manipulation task, in this example, consists of pushing or moving particle p1 in the direction of location T1 and moving particle p2 in the direction of T2.

According to the invention, the control unit 60 is designed for:
controlling the heating device 20 and the imaging device 40,
evaluating image data 52 from the imaging device 40 at least with regard to a spatial configuration of the particle p and
determining at least one force acting on the particle p by evaluating the spatial configuration of the particle p.

The control unit 60 can furthermore be designed for:
A) activating the imaging device 40 to capture an actual spatial configuration of the particle(s) p1, p2 within the receptacle 10,
B) determining control signals for the heating device 20 suitable for a specific dynamic localized heating event to be applied to the fluid 12 in dependence of at least one recent spatial configuration of the particle(s) p1, p2 and a previously defined target configuration T1, T2 of the particle(s) p1, p2,
C) activating the heating device 20 to apply the specific dynamic localized heating event as determined in step B) at least once to the fluid 12 and
D) repeating at least one or all of the steps A) to C).

Further devices for manipulating the sample, and specifically the particles p1, p2, to be spatially manipulated, e.g., further lasers can be present in the apparatus 100 of FIG. 2.

The control unit 60 can be a PC or a similar computing device with peripheral components as generally known in the art. The control unit 60 can have both a computer program product and a computer-readable storage medium according to the invention.

The aspects of the invention relating to the spatial manipulation using a feedback from captured spatial configurations will be described in the following with reference to FIGS. 3 to 5. It is important to note, though, that the feedback from captured actual spatial configurations is not a necessary feature of the invention which is concerned with force measurements.

Embodiments of the invention will then be described with reference to FIGS. 6 to 13. The essential features of the spatial manipulation of particles p1, p2 in a fluid 12 will now be described, first more generally with regard to FIG. 3 and subsequently in more detail with reference to FIG. 4. More specifically, we describe in the following with reference to FIGS. 3 and 4 aspects relating to the spatial manipulation of the particles of the embodiment of the method according to the invention where at least one target spatial configuration T1, T2 of the particle(s) p1, p2 in the fluid 12 is defined and the following further steps are carried out:
a) an actual spatial configuration of the particle(s) is captured,
b) a specific dynamic localized heating event to be applied to the fluid 12 is determined in dependence of at least one recent actual spatial configuration of the particle(s) p1, p2 and a target configuration T1, T2 of the particle(s) p1, p2,
c) the specific dynamic localized heating event as determined in step b) is applied at least once to the fluid 12 and
d) at least one or all of steps a) to c) are repeated.

The upper portion of FIG. 3 shows three schematic drawings a1, a2, and a3, of a receptacle 10 containing, as in FIG. 1, particles p1, p2 to be spatially manipulated, i.e., to be moved from actual locations to target locations T1 and T2 or to be pushed in the direction of T1 and T2, respectively. Drawing a1 shows the initial configuration where the particles p1 and p2 are far away from the target locations T1 and T2 to which they are to be moved. Drawing a2 schematically shows, represented by dotted arrows, the hydrodynamic flows or thermoviscous flows to be generated in the fluid 12. Drawing a3 shows the situation after a specific dynamic localized heating event has been applied. As can be seen in drawing a3, particle p1 has successfully been moved to the corresponding target location T1 and the distance between particle p2 and its target location T2 is at least smaller as compared to the initial situation of drawing a1.

The lower portion of FIG. 3 depicts essential steps of the spatial manipulation of particles p1, p2 in a fluid 12.

First (drawing b1), an actual spatial configuration of the particles p1, p2 is captured (step a)), e.g., an image is recorded with the camera 50 of the microscope 40 in FIG. 1.

Then, in the example shown in FIG. 3, the particles to be manipulated are localized, i.e., the coordinates of the respective particles p1, p2 are identified (drawing b2).

After definition of a target spatial configuration of the particles p1, p2, i.e., in the example of FIG. 3, after definition of target locations T1, T2, paths for both particles p1 and p2 to reach their respective target locations T1, T2, are calculated (drawing b3).

According to step b) of a variant of method according to the invention, a specific dynamic localized heating event to be applied to the fluid 12 is then determined in dependence of at least one recent actual spatial configuration of the particles p1, p2, e.g., in dependence of at least the image recorded in step a) (drawing b1) and the target locations T1, T2 of the particles p1, p2.

According to step c) of this variant, the specific dynamic localized heating event as determined in step b) is applied at least once to the fluid 12. In the example shown in FIG. 3, the specific dynamic localized heating event is applied to the fluid 12 by appropriately scanning, e.g., with scanner 26 in FIG. 1, the heating radiation 24 through the sample (drawing b4).

Thus, the particles p1, p2 are spatially manipulated in the fluid 12 by hydrodynamic flows which are generated in the fluid 12 by means of dynamic localized heating of the fluid 12.

According to step d), at least one or all of the steps a) to c) is or are repeated. In the example shown in FIG. 3, the cycle of steps a) to c) is repeated, e.g., with 30 Hz.

A more detailed example of a method for spatially manipulating the particles will be described with reference to FIG. 4. In step S01 “initialize targets”, at least one target spatial configuration of the particle(s) to be manipulated in the fluid is defined. Then, in step S02, an image of the sample is acquired, which corresponds to step a) of capturing an actual spatial configuration of the particle(s) to be manipulated. This can be realized, e.g., by the acquisition of a microscopic image, see description of FIG. 1. In the example of FIG. 4, the particles are then tracked in step S03, i.e., particles present in the actual configuration captured in step S02 are identified with particles in the most recent actual configuration. In step S04, the particles to be manipulated are associated, in each case, with a target position. In step S05 “compute error”, a cost function is calculated in dependence of a recent actual spatial configuration of the particles p1, p2, e.g., the image acquired in step S02, and a target configuration T1, T2 of the particles p1, p2, e.g., the target configuration or locations defined in step S01.

According to step b) of the above method, a specific dynamic localized heating event to be applied to the fluid 12 will then be determined in step S06 “compute new FLUCS vector”, e.g., in dependence of the cost function calculated in step S05. Thus, the specific dynamic localized heating event will be dependent of at least one recent actual spatial configuration of the particles and a target configuration of the particles. It is also possible, though, that the specific dynamic localized heating event to be applied to the fluid 12 is determined irrespectively of the cost function value, e.g., by selecting the furthermost particle and pushing it towards its target.

In step S07 “apply FLUCS vector”, the specific dynamic localized heating event determined in step S06 is applied to the sample, i.e., to the fluid containing the particles to be manipulated. This corresponds to step c) of the above method.

According to step d) of the method, at least some of steps a) to c) are repeated. In the flowchart depicted in FIG. 4, a new image is acquired in step S08, i.e., step a) of the method is repeated. This is followed by a further tracking of the particles in step S09, i.e., the particles present in the actual configuration captured in step S08 are identified with particles present in the actual configuration captured in step S08, i.e., for each of the particles a path is obtained.

Step S10 is a query whether or not a target configuration is to be updated. In preferred embodiments the software decides whether or not the target configuration will be updated.

In the case where the target configuration is left unchanged, the query S10 is followed by step S11 where, as in step S04, the particles to be manipulated are associated, in each case, with a target position. In the case where in response to the query in step S10 the target configuration is to be updated, a new target configuration, e.g., new target locations are defined in step S14 “define new targets” and the program continues with step S11.

Step S11 is followed by step S12 in which, as in step S05, the cost function is calculated anew for the new actual configuration of the particles as captured in step S08 and, if applicable, for the new target configuration as defined in step S14.

In step S13 it is decided whether or not the error, i.e., the cost function, has decreased as compared to the value determined in step S05.

If the cost function has, in fact, decreased from the value determined in step S05, step c) being realized in the example of FIG. 4 by step S07 is repeated with the same specific dynamic localized heating event as determined in step S06.

If, on the other hand, the cost function has increased from the value determined in step S05, step b) of the method is carried out anew. I.e., a new specific dynamic localized heating event to be applied to the fluid 12 will be determined in step S06 “compute new FLUCS vector” in dependence of the cost function calculated in step S12.

Thus, a closed feedback-loop control and an automated spatial manipulation of particles in a fluid are realized.

FIG. 5 shows in schematic diagrams 1 to 3 how two particles p1 and p2 are brought close together using thermoviscous flows. Diagram 1 shows the initial situation. A first specific dynamic localized heating event is determined and applied which moves particle p2 closer to the centre. Then, as depicted in diagram 2, a second specific dynamic localized heating event is determined and applied which brings particle p1 closer to the centre and in a location adjacent to particle p2. Diagram 3 shows the final configuration of particles p1 and p2.

An embodiment of the invention will now be described with reference to FIGS. 6 to 13.

To achieve an optically induced, hydrodynamic trap, two opposing thermoviscous flows were generated by splitting the scanning line of a relay laser into two counterdirected paths. FIG. 6 shows schematically the generated inhomogeneous field u(x) of hydrodynamic flows. This approach requires no intersecting microchannels. The direction of laser scanning dictates the direction of the induced flows, and a stagnation point S is formed between the arbitrarily chosen laser scan paths (horizontal arrows in FIG. 6 directed to the stagnation point S), where a microscopic particle can be trapped.

This represents a weak metastable confinement as the restoring character of the trap is only observed along the compressional axis, i.e., in the horizontal direction in FIG. 6, and consequently, any positional fluctuation along a perpendicular axis (vertical arrows in FIG. 6) would result in the expulsion of the particle.

To avoid such an expulsion, an active feedback control is used that enables dynamic rotation of the counterflows and rapid readjustment of the two in-plane axes (FIG. 7).

In the terms of the claims, the inhomogeneous field of hydrodynamic flows \vec{u(x)} shown in FIG. 6 comprises a stagnation point S and a particle p can be trapped at least temporarily in the vicinity of this stagnation point S. The inhomogeneous field \vec{u(x)} of hydrodynamic flows of FIG. 6 is generated by two hydrodynamic flows f directed in opposite directions toward the stagnation point S. The two hydrodynamic flows f directed in opposite directions are dynamically rotated (indicated by double arrows in FIG. 7a) in a plane around the stagnation point S. More specifically, an azimuthal direction in which the two hydrodynamic flows f directed in opposite directions are applied is chosen in dependence of a captured spatial configuration of the particle p. E.g., the azimuthal direction can be chosen in dependence of at least one of the measured azimuthal and radial coordinates of the particle p in relation to the stagnation point S. The stagnation point S can be considered an embodiment of a target location.

FIG. 7a) shows a deviation or of an actual position of the particle p from the stagnation point S. This deviation or can be observed and a force acting on the particle p can be determined in dependence of this deviation or. FIGS. 7b), 7c), and 7d) show, in each case, different directions of the applied thermoviscous flows and the location of the particle p and the stagnation point S. Whereas in FIGS. 7b) and 7d) the particle p is very close to the stagnation point S, in the situation of FIG. 7c), the particle p is considerably spaced from the stagnation point S.

The stiffness of the trap is tuneable as it depends on the power of the scanning laser, the frequency of scanning and the update rate of the scan paths, along with many other user-specified parameters.

Further properties of the trap can be evaluated by intermittently switching the trap on and off. The results of such measurements are illustrated in the diagram of FIG. 8 which shows the radial displacement of a particle from the stagnation point S over time.

As soon as the laser is turned on, the particle p is dragged towards the stagnation point S corresponding to the solid lines in the diagram of FIG. 8. When, on the other hand, the laser is turned off, the particle p diffuses out again in a Brownian-like manner corresponding to the dotted lines in the diagram of FIG. 8.

FIG. 9 shows a histogram of the phase space explored by the trapped particle in water that indirectly shapes the outlines of the trap profile. Such histograms are also termed heat maps. The histogram depicts the number of times (Counts, vertical axis) the particle was found at a certain distance (horizontal axis) from the stagnation point S.

The histogram of FIG. 9 corresponds to the profile of the trapping potential. The potential appears to be symmetric, confirming that the restoring force achieved by dynamic rotation of the laser scan paths, see FIG. 7, is independent of the direction of the particle displacement from the stagnation point. This in effect creates a quasi-1D trapping situation, where the particle appears always to be displaced along the compressional axis.

This can be confirmed by an analysis of the mean squared displacement (MSD) of the particle p which is illustrated in FIG. 10. FIG. 10 is a diagram showing the power spectral density functions of the mean-squared displacement of a particle p obtained from the raw positional data of the particle p. Similar to optical tweezers, power spectral density (PSD) roll-off analysis can be used to obtain a Lorentzian fit to the Fourier-transformed flow-trapping data and thus yield an accurate estimate of the trap stiffness along each transverse coordinate. FIG. 10 shows the data for the x-coordinate. The symmetry of the trap is evident from the agreement between the two in-plane trap stiffnesses with the x-coordinate represented by kx which overlap within the calculated uncertainties. The data for the y-coordinate are not shown.

The transition between short- and long-term diffusion is marked in the PSD plot by a corner frequency f_{c} which allows an accurate estimation of the trap stiffness k along each orthogonal axis via:

$${f}_{c} = k / ( 12 {π}^{2} η R )$$

Using this approach, one obtains a trap stiffness of 35±5 fN/μm (femtonewtons/micrometre) along the x-axis, which is at least as sensitive as that obtained with typical optical tweezers. Thus, optically induced thermoviscous flows appear able to generate highly sensitive traps without direct exposure to a laser and with only a moderate degree of heating.

To perform sensitive force measurements, it is essential that the displacement from a trapping point can be used as a readout of the force to which a particle is subjected. One can therefore investigate the force-extension relationship displayed by the optically induced hydrodynamic trap. For the determination of the velocity-distance relationship one can use a Stokes' drag calibration, i.e., an approach which has also been used to verify the approximately harmonic trapping potential generated by optical tweezers.

One can displace a trapped particle away from the stagnation point and then follow its relaxation behaviour. The inventors observed an exponential approach of the particle to the stagnation point, suggesting a linear velocity-displacement relationship, where a particle displaced further from the trap is dragged towards the stagnation point at a faster rate, reminiscent of a Hookean spring. The trapping timescale in optical tweezer experiments is given by:

$$τ = 6 πηR / k$$

This can be used to obtain a second estimate of the trap stiffness. This estimate produced a value as low as 33±3 fN/μm and thus agreed closely with the previous PSD roll-off estimate. Given the linear force-displacement relationship, these results suggest that the optically induced hydrodynamic trapping approach of the invention can be used to measure forces in the femtonewton range.

External forces can be used to further confirm the properties of the trap and can also serve the purpose of calibration. This will be described in connection with FIGS. 11 to 13. For the experiments underlying the data of FIGS. 11 to 13, an external custom-made electromagnetic needle M and a magnetic particle p were used to establish a force balance and to quantify the counterflow trap forces. The magnetic force can be tuned by steady variation of the current applied to the electromagnet. In the absence of any flows, the active magnetic driving of the particle p has an attractive pulling effect, as expected, which can be verified by the ballistic motion at long lag times (not shown).

Increasing the current allows the particle to explore a larger region of space for the same acquisition duration, reflecting the enhanced magnetic pulling forces. By extracting the long-time (steady-state) velocity of the particle in each case, it is possible to calibrate the magnetic forces through a force balance with a known Stokes' drag force via the expression

$$\vec{{F}_{d}} = 6 π η R \vec{u ( x )}$$

Next, the inventors asked if the apparent spring constant that was indicated by the particle dynamics in the absence of external forces can be confirmed when pulling on the particle using an external force. This will be described with reference to FIG. 11. FIG. 11a) is a snapshot of the position of the magnetic particle without any external force and when the trap was active, i.e., when the counterdirected flows were acting. The particle was again observed to explore a very narrow region near the stagnation point formed between the two scan paths. The particle corresponds to the dark spherical structure in FIG. 11a) which is essentially at the location of the stagnation point which is represented by the white circle.

The application of a driving current to the electromagnet M and the subsequently induced magnetic field results in pulling the particle away from the stagnation point. This is shown in FIG. 11b) where the trap is again active and the external electromagnetic force Fext realized by electromagnet M was switched on and, as can be seen, particle p is drawn away by or from the stagnation point S. Thus, the local minimum of the potential energy for the particle is shifted in the direction of the magnetic field source.

The magnitude of the shift depends on the magnetic force strength, and larger currents produce larger displacements from the stagnation point.

This is illustrated with reference to FIG. 12. FIG. 12 shows the displacement over time for different magnitudes of the current through the electromagnet. From curve s to curve k, the current through the electromagnet M is increased in steps of 0.2 A, respectively.

By relating the applied current to the calculated magnetic force, the linear force-extension relationship can be fitted and, thus, yet another estimate of the counterflow trap stiffness can be obtained. This is illustrated in FIG. 13 which shows the deviation or experienced by the particle under the influence of an external force plotted against the calculated magnetic force. The trap stiffness found in this way closely matches the order-of-magnitude of the two previous estimates and was at most two standard deviations away. Importantly, the counterflow forces determined by the application of well-controlled magnetic forces can be used to quantify any other externally applied unknown force in the setup.

The explicit application of an external force confirms that equilibrium thermodynamics can indeed be used to accurately describe the relaxation dynamics following a positional perturbation. Furthermore, histograms reflecting the fluctuations of the magnetic particle around its steady-state position, at which the counterflows balance precisely the magnetic force, reveal that the measurements are close to thermally limited. The detection of smaller forces is accompanied with a wider potential that enables trapping over a larger phase space than is currently achievable with most point-trap optical-tweezer setups, where the focal spot is typically diffraction-limited. In addition, the optically generated hydrodynamic trap of the invention is highly tuneable, enabling further optimization through increased laser power, elongated scan path length or reduced counterflow update rate.

A further embodiment of a method according to the invention will be described with reference to FIG. 14. FIG. 14 shows a situation where a field of hydrodynamic flows having two separate stagnation points S1 and S2 is generated by suitable scanning patterns with a laser.

More specifically, by scanning the laser beam in the directions of arrows s1 and s2 hydrodynamic flows in the direction of arrows f1 to f4 are generated. The first stagnation point S1 is generated at the position where flows f1 and f4 hit each other.

By scanning the laser beam furthermore in the directions of arrows s3 and s4 hydrodynamic flows in the direction of arrows f5 to f8 are generated. The second stagnation point S2 is generated at the position where flows f5 and f8 meet.

The target to be manipulated and analysed in this example is a tethered molecule comprising two terminal particles p1 and p2 as well as a schematically drawn molecular chain C connecting p1 and p2. Particle p1 is trapped as described above in the vicinity of stagnation point S1. Particle p2 is trapped in the vicinity of stagnation point S2. The forces driving particles p1 and p2 back to the stagnation point S1 and S2, respectively, in a situation where no force is exerted by the molecular chain can be measured as described above. For this purpose, either the flows f1 to f4 generating stagnation point S1 or the flows f5 to f8 generating stagnation point S2 are activated.

The forces F1 and F2 exerted by the molecular chain C on the particles p1 and p2 can then be measured by varying the distance between stagnation point S1 and stagnation point S2 and observing the deviations of particles p1 and p2 from stagnation points S1 and S2, respectively, in dependence of the distance S1-S2.

A specific advantage of the arrangement of FIG. 14 is that in the entirety of region R no heating radiation from the laser hits the fluid 12 and, correspondingly, no heating radiation from the laser hits the tethered molecule p1-C-p2 under investigation.

Overall, the inventors disclose a highly sensitive and tuneable contact-free trap generated by two counterdirected optically induced thermoviscous flows. This novel approach can be highly relevant to address the rising concerns regarding the heating effect and possibility of photodamage due to the application of optical trapping in in-vivo systems as well as the geometrical limitations of microfluidic traps. The arbitrarily defined scan paths and resulting stagnation point render this approach highly localized and flexible. The induced levels of heating due to the laser scanning are moderate and would be easily tolerable by in-vivo systems. Thus, the approach of the invention is likely to have a plethora of applications in the life sciences, ranging from cell biology to embryonic development. In the context of materials science, the method is highly suitable for the determination of the viscoelastic properties of complex fluids. Finally, the ability of the counterflow trap to sense femtonewton forces on a micrometre scale may prove particularly advantageous in the field of mechanobiology for the detection of local mechanical cues driving key cellular processes, such as differentiation and proliferation.

With the present disclosure, the inventors present a novel, non-contact trapping method based on optically induced hydrodynamic flows. The inventors demonstrate a linear force-extension relationship that can detect femtonewton-range forces with near thermally limited sensitivity. The presented technology removes the need for lasers to touch particles and there are no material constraints on the particles that can be analysed. Furthermore, the methodology can be employed with standard optical microscopes without a requirement for specialist chambers, making it possible to investigate localized forces within more complex materials. Thus, optically induced hydrodynamic flows facilitate highly sensitive, non-invasive force measurements within a wide range of samples.

### LIST OF REFERENCE NUMERALS AND ABBREVIATIONS

10 receptacle, sample chamber
12 fluid, e.g. water
20 heating device
22 radiation source, e.g. infrared laser
24 heating radiation
26 scanner
28 beam shutter
30 means for coupling of the light beam, e.g. dichroic mirror
40 microscope, e.g. fluorescence microscope
42 imaging light source
44 imaging radiation
46 filter cube, consisting, e.g., of excitation, dichroic, and emission filters
48 objective
50 detector for imaging radiation, e.g. camera
52 image data
60 control unit, e.g. PC
100 apparatus according to the invention
C molecular chain
p, p1-p6 particles to be manipulated and/or positioned
f, f1-f8 direction of hydrodynamic flows
F force acting on a particle
F1 force acting on particle p1
F2 force acting on particle p2
Fext external force acting on a particle
FLUCS Focused Light Induced Cytoplasmic Streaming
R region where no heating radiation enters the fluid
S, S1, S2 stagnation points, target location
T1-T3 target locations
\vec{u}, \vec{u(x)}, \vec{u(x,y)} inhomogeneous field of hydrodynamic flows
δr deviation of actual position of particle from stagnation point

### REFERENCES

[1] Gomez, G. A., Mclachlan, R. W. & Yap, A. S. Productive tension: force-sensing and homeostasis of cell-cell junctions. Trends Cell Biol. 21, 499-505 (2011).
[2] Petridou, N. I., Spiró, Z. & Heisenberg, C.-P. Multiscale force sensing in development. Nat. Cell Biol. 19, 581-588 (2017).
[3] Beech David J. & Kalli Antreas C. Force Sensing by Piezo Channels in Cardiovascular Health and Disease. Arterioscler. Thromb. Vasc. Biol. 39, 2228-2239 (2019).
[4] Gardel, M. L., Kasza, K. E., Brangwynne, C. P., Liu, J. & Weitz, D. A. Chapter 19 Mechanical Response of Cytoskeletal Networks. in Methods in Cell Biology vol. 89 487-519 (Academic Press, 2008).
[5] Ashkin, A., Dziedzic, J. M., Bjorkholm, J. E. & Chu, S. Observation of a single-beam gradient force optical trap for dielectric particles. Opt. Lett. 11, 288-290 (1986).
[6] Capitanio, M., Cicchi, R. & Pavone, F. S. Position control and optical manipulation for nanotechnology applications. Eur. Phys. J. B-Condens. Matter Complex Syst. 46, 1-8 (2005).
[7] Kotsifaki, D. G. & Chormaic, S. N. Plasmonic optical tweezers based on nanostructures: fundamentals, advances, and prospects. Nanophotonics 8, 1227-1245 (2019).
[8] Stoev, I. D., Caciagli, A., Xing, Z. & Eiser, E. Using single-beam optical tweezers for the passive microrheology of complex fluids. in Optical Trapping and Optical Micromanipulation XV vol. 10723 107232D (International Society for Optics and Photonics, 2018).
[9] Brouhard, G. J., Schek, H. T. & Hunt, A. J. Advanced optical tweezers for the study of cellular and molecular biomechanics. IEEE Trans. Biomed. Eng. 50, 121-125 (2003).
[10] Shan, X. et al. Optical tweezers beyond refractive index mismatch using highly doped upconversion nanoparticles. Nat. Nanotechnol. 16, 531-537 (2021).
[11] Tassieri, M. Linear microrheology with optical tweezers of living cells ‘is not an option’! Soft Matter 11, 5792-5798 (2015).
[12] Tassieri, M. Microrheology with Optical Tweezers of gel-like materials “is not an option”! in Optics in the Life Sciences (2015), paper OtM4E.1 OtM4E.1 (Optical Society of America, 2015).
[13] F. M. Weinert, J. A. Kraus, T. Franosch and D. Braun, Phys. Rev. Lett., 2008, 100, 164501.
[14] F. M. Weinert and D. Braun, Journal of Applied Physics, 2008, 104, 104701.
[15] M. Mittasch, P. Gross, M. Nestler, A. W. Fritsch, C. Iserman, M. Kar, M. Munder, A. Voigt, S. Alberti, S. W. Grill and M. Kreysing, Nat Cell Biol, 2018, 20, 344-351.
[16] M. Mittasch, V. M. Tran, M. U. Rios, A. W. Fritsch, S. J. Enos, B. Ferreira Gomes, A. Bond, M. Kreysing and J. B. Woodruff, Journal of Cell Biology, DOI:10.1083/jcb.201912036.
[17] N. T. Chartier, A. Mukherjee, J. Pfanzelter, S. Fürthauer, B. T. Larson, A. W. Fritsch, M. Kreysing, F. Julicher and S. W. Grill, bioRxiv, 2020, 2020.05.30.125864.

1. Method for measuring a force on at least one particle in a fluid, the method comprising:
generating an inhomogeneous field of hydrodynamic flows in a fluid by specific dynamic localized heating events,
spatially manipulating the particle by the hydrodynamic flows,
capturing a spatial configuration of the particle(s) within the fluid, and
determining at least one force acting on the particle(s) by evaluating the captured spatial configuration of the particle(s).

2. Method according to claim 1,
wherein
the field of hydrodynamic flows decreases in the direction of the field.

3. Method according to claim 1,
wherein
the fluid is or contains water.

4. Method according to claim 1,
wherein
the particle(s) to be manipulated is (are) at least one of the following: a biological particle, a cell, a virus, a tissue fragment, a metal particle, a composite material particle, a polymer particle, a nanoparticle, a spherical bead, a magnetic bead, a tethering molecule, a cellular organelle, a phase-separated droplet that itself is containing protein, RNA, or other biomolecules, a tethering molecule.

5. Method according to claim 1,
wherein
the dynamic localized heating of the fluid is brought about by a laser or an infrared laser or at least one infrared light emitting diode.

6. Method according to claim 5,
wherein
the dynamic localized heating events of the fluid are brought about by repetitive scanning of a focal volume of the laser along a path in the fluid.

7. Method according to claim 1,
wherein
a determination of a specific dynamic localized heating event to be applied to the fluid comprises the determination of at least one of:
2-dimensional scan path in the fluid,
3-dimensional scan path in the fluid,
laser intensity,
laser scanning speed,
scanning frequency of the laser, or
number of times the scanning path is scanned.

8. Method according to claim 5,
wherein
the paths along which the laser is scanned is chosen such that the heating radiation does not hit the particle(s) to be manipulated.

9. Method according to claim 6,
wherein
a scan rate of the repetitive scanning is chosen such that temperature fields in the sample can relax between successive scans.

10. Method according to claim 1,
wherein
the spatial manipulation of the particle(s) comprises at least one of:
pushing or moving specified particle(s) towards specified target locations in the fluid,
moving specified particle(s) along specified paths in the fluid,
keeping specified particle(s) in specified target locations in the fluid,
keeping specified particle(s) in specified target orientations in the fluid, or
pushing or moving specified particle(s) towards specified target orientation(s) in the fluid.

11. Method according to claim 1,
wherein
the capturing of the actual spatial configuration of the particle(s) comprises at least one of the following:
a 1-dimensional position of the particle(s),
a 2-dimensional position of the particle(s),
a 3-dimensional position of the particle(s),
a measurement of an orientation of the particle(s) within a plane, or
a measurement of a 3-dimensional orientation of the particle(s) in space.

12. Method according to claim 1,
wherein
the inhomogeneous field of hydrodynamic flows comprises at least one stagnation point and the at least one particle is trapped at least temporarily in the vicinity of the stagnation point.

13. Method according to claim 12,
wherein
a deviation of an actual position of the at least one particle from the stagnation point is observed and the force acting on the particle is determined in dependence of this deviation.

14. Method according to claim 12,
wherein
the inhomogeneous field of hydrodynamic flows comprising at least one stagnation point is generated by at least two hydrodynamic flows directed in opposite directions toward the stagnation point.

15. Method according to claim 14,
wherein
the at least two hydrodynamic flows directed in opposite directions are rotated in a plane around the stagnation point.

16. Method according to claim 15,
wherein
an azimuthal direction in which the at least two hydrodynamic flows directed in opposite directions are applied is chosen in dependence of a captured spatial configuration of the particle.

17. Method according to claim 1,
wherein
at least one external force is applied to the particle.

18. Method according to claim 17,
wherein
the external force is at least one of:
a magnetic force;
an electrostatic force;
a gravitational force;
a force generated by an optical trap; or
a force exerted by a tethered molecule.

19. Method according to claim 17,
wherein
the external force is time-dependent or constant for at least a specified period of time.

20. Method according to claim 17,
wherein
the force acting on the particle is calibrated by comparison to the external force.

21. Method according to claim 1,
wherein
the force acting on the particle is determined by evaluation of a statistical distribution, e.g., of the lateral positions of the particle in the vicinity of a stagnation point and a temperature of the fluid.

22. Method according to claim 1,
wherein
at least two particles are simultaneously spatially manipulated and/or that forces acting on at least two particles are simultaneously determined.

23. Method according to claim 1,
wherein
for at least one particle, a torque acting on the respective particle is determined.

24. Method according to claim 1,
wherein
that the fluid contains particles which enable a capturing of the field of hydrodynamic flows.

25. Method according to claim 24,
wherein
the specific localized heating events are determined in dependence of at least one of:
a recently captured spatial configuration of the particle(s), or
a recently captured field of hydrodynamic flows.

26. Method according to claim 1,
wherein
at least one target spatial configuration of the particle(s) in the fluid is defined and
wherein the following further steps are carried out:
a) an actual spatial configuration of the particle(s) is captured,
b) a specific dynamic localized heating event to be applied to the fluid is determined in dependence of at least one recent actual spatial configuration of the particle(s) and a target configuration of the particle(s),
c) the specific dynamic localized heating event as determined in step b) is applied at least once to the fluid and
d) at least one or all of steps a) to c) are repeated.

27. Method according to claim 26,
wherein
the target spatial configuration of the particle(s) in the fluid comprises at least one of:
specified target location(s) of the particle(s) in the fluid,
specified target velocity or velocities of the particle(s) in the fluid,
specified target orientation(s) of the particle(s) in the fluid,
specified target rotation speed(s) of the particle(s) in the fluid.

28. Method according to claim 26,
wherein
the target spatial configuration of the particle(s) in the fluid is
a 1-dimensional localization of the particle(s),
a 2-dimensional localization of the particle(s) or
a 3-dimensional localization of the particle(s).

29. Method according to claim 26,
wherein
a cost function is calculated on the basis of a recent actual spatial configuration of the particles and a target configuration of the particles and, in particular,
the specific dynamic localized heating event to be determined in step b) is determined in dependence of the cost function.

30. Method according to claim 26,
wherein
the following data are stored in a database:
previous actual spatial configurations of the particle(s),
previous dynamic localized heating events applied to the fluid determined on the basis of at least a respective actual spatial configuration and a target configuration and
changes in the actual spatial configurations of the particle(s) caused by the respective dynamic localized heating event applied to the fluid,
and wherein future dynamic localized heating events to be applied to the fluid are calculated using at least parts of the data stored in the database.

31. Method according to claim 1,
wherein
future dynamic localized heating events to be applied to the fluid are calculated using machine learning.

32. Method according to claim 1,
wherein:
the particle to be manipulated and analysed is a tethered molecule,
a flow field having at least two stagnation points is generated within the fluid, and
at least two portions of the tethered molecule are held in the stagnation points by the hydrodynamic fluids.

33. Apparatus for measuring a force on at least one particle in a fluid, the apparatus comprising:
a receptacle for receiving the fluid and the particle,
a heating device for generating an inhomogeneous field of hydrodynamic flows within the fluid by specific dynamic localized heating events,
a device for capturing at least parts of a spatial configuration of the particle(s) within the receptacle and having a control unit
for controlling the heating device and the device for capturing at least parts of a spatial configuration of the particle(s),
for evaluating data from the device for capturing at least parts of a spatial configuration of the particle(s) and
for determining at least one force acting on the particle by evaluating the spatial configuration of the particle.

34. Apparatus according to claim 33,
wherein
the device for capturing at least parts of a spatial configuration of the particle(s) is at least one of:
an imaging device;
a lenseless camera; or
a quadrant photodiode.

35. (canceled)

36. Apparatus according to claim 33,
wherein
the receptacle has means for controlling the temperature of the fluid.

37. Apparatus according to claim 33,
wherein
the heating device has a laser for providing the energy for the dynamic localized heating and optical means including a scanner for relaying heating laser radiation to variable locations in the fluid.

38. Apparatus according to claim 33,
wherein
the imaging device is a microscope.

39. Apparatus according to claim 38,
wherein
the microscope is designed for carrying out at least one of the following techniques: Fluorescence Microscopy, Multi-Photon Fluorescence Microscopy, Widefield Microscopy, Scanning Microscopy, Dark-Field Microscopy, Confocal Microscopy, Light Sheet Microscopy, Localization Microscopy, Structured Illumination Microscopy, Photoactivated Localization Microscopy (FPALM), Stochastic Optical Reconstruction Microscopy (STORM), Stimulated Emission Depletion Microscopy (STED), Ground State Depletion Microscopy (GSD), Saturated Pattern Excitation Microscopy, Saturated Structured Illumination Microscopy (SSIM), Light Field Microscopy (LFM), Fourier Light Field Microscopy (FLFM), or Oblique Plan Microscopy (OPM).

40. Apparatus according to claim 33,
wherein
the control unit (60) is designed for:
A) activating the device for capturing at least parts of a spatial configuration of the particle(s) to capture an actual spatial configuration of the particle(s) within the receptacle,
B) determining control signals for the heating device suitable for a specific dynamic localized heating event to be applied to the fluid in dependence of at least one recent spatial configuration of the particle(s) and a previously defined target configuration of the particle(s),
C) activating the heating device to apply the specific dynamic localized heating event as determined in step B) at least once to the fluid and
D) repeating at least one or all of the steps A) to C).

41. A computer program product comprising instructions stored on a non-transitory computer-readable medium which,
when the program is executed by the control unit, causes the control unit to carry out a method with the steps of:
A) activating the device for capturing at least parts of a spatial configuration of the particle(s) to capture an actual spatial configuration of the particles within the receptacle,
B) determining control signals for the heating device suitable for a specific dynamic localized heating event to be applied to the fluid in dependence of at least one recent spatial configuration of the particle(s) and a previously defined target(s) configuration of the particle(s),
C) activating the heating device to apply the specific dynamic localized heating event as determined in step B) at least once to the fluid,
D) repeating at least one or all of the steps A) to C), and
E) determining a force acting on a particle in dependence of a captured spatial configuration of the particle(s).

42. A non-transitory computer-readable storage medium comprising instructions which, when executed by the control unit, cause the control unit to carry out a method, with the steps of:
A) activating the device for capturing at least parts of a spatial configuration of the particle(s) to capture an actual spatial configuration of the particles within the receptacle,
B) determining control signals for the heating device suitable for a specific dynamic localized heating event to be applied to the fluid in dependence of at least one recent spatial configuration of the particles and a previously defined target configuration of the particles,
C) activating the heating device to apply the specific dynamic localized heating event as determined in step B) at least once to the fluid,
D) repeating at least one or all of the steps A) to C), and
E) determining a force acting on a particle in dependence of a captured spatial configuration of the particle(s).
